(19) United States
(12) Patent Application Publication
(10) Pub. No.: US 2012/0026826 A1
(43) Pub. Date: Feb. 2, 2012

(54) BLENDING ASSEMBLY WITH AUTOMATED DISPENSING VALVE

(75) Inventor: John A. BROADBENT, Denver, CO (US)

(73) Assignee: Scotsman Industries, Inc., Denver, CO (US)

(21) Appl. No.: 13/106,531

(22) Filed: May 12, 2011

Related U.S. Application Data
(60) Provisional application No. 61/345,731, filed on May 18, 2010.

(51) Int. Cl. B01F 15/02; B01F 7/22

(52) U.S. Cl. 366/192

(57) ABSTRACT

A blending assembly that comprises a blender base that has an actuating member and a control mechanism, and a container that is removably mountable on the blender base. The container has an integral dispensing spout and dispensing valve. The dispensing valve opens and closes the dispensing spout. The container is adapted to receive ingredients. The control mechanism operates an impeller of the container to blend the ingredients and operates the actuating member to engage the dispensing valve to move the dispensing valve between open and closed positions with respect to the container, thereby opening and closing the dispensing spout for dispensing the blended ingredients.

### RELATED APPLICATION

The present application claims priority under 35 U.S.C. §119 to U.S. Provisional Application No. 61/345,731, filed May 18, 2010.

### FIELD OF THE INVENTION

The present invention relates generally to beverage mixers, smoothie makers, blenders, and the like. More particularly, the present invention relates to blending assembly with an automatic dispensing valve that is actuated automatically by a control mechanism in the blender base.

### BACKGROUND OF THE INVENTION

Frozen, frosty, or icy drinks, such as shakes or smoothies, have become increasingly popular. Shakes, or milk shakes, are typically formed of ingredients, such as ice-cream and/or milk, and flavored as desired, with or without additives, such as candies, chocolates, peanut butter, etc. Milkshakes typically are available at most fast-food restaurants, such as burger chains, and often require special machines to make. Smoothies tend to be healthier, are usually formed of ice, frozen yogurt, and/or sorbet, and also can include additives such as fruit, berries, fruit juice, vitamins, etc. Smoothies are typically available from specialty chains, juice bars, and fast-food restaurants and can be made with commercial or restaurant-grade blenders.

Milkshakes and smoothies are typically prepared by first placing all the ingredients into a blending container. Once the ingredients have all been added into the container and the container is placed onto the blender base, the blender motor can then be energized to blend the ingredients to the desired consistency.

Once the blending of a smoothie or beverage is completed, it is necessary to first remove the container from the blender and pour the contents into a drinking cup or glass. It will be appreciated that the container has an open top that is substantially larger than a typical drinking cup or glass. Thus, it is common for the contents to then pour out of the wider opening of the container, and outside the narrower cup or glass, creating a mess to clean-up, and wasting the contents. In addition, it will be appreciated that the shakes or the smoothies tend to be thick and/or viscous, and thus are often difficult to pour.

Therefore, a need exists for a beverage blending assembly that facilitates the dispensing of its contents. In addition, there is a need for a beverage blending assembly in which the steps of blending, dispensing, rinsing and draining the container are automated.

### SUMMARY OF THE INVENTION

Accordingly, the present invention provides a blending assembly that comprises a blender base that has an actuating member and a control mechanism, and a container that is removably mountable on the blender base. The container has an integral dispensing spout and dispensing valve. The dispensing valve opens and closes the dispensing spout. The container is adapted to receive ingredients. The control mechanism operates an impeller of the container to blend the ingredients and operates the actuating member to engage the dispensing valve to move the dispensing valve between open and closed positions with respect to the container, thereby opening and closing the dispensing spout for dispensing the blended ingredients.

The present invention may also provide a blending assembly that comprises a blender base and a container removably mountable on the blender base. The container has an integral dispensing spout and dispensing valve. The dispensing valve opens and closes the dispensing spout. The container is adapted to receive ingredients. The blending assembly has a means for automatically actuating the dispensing valve between open and closed positions and dispensing the ingredients from the container.

The present invention may also provide a method of operating a blending assembly wherein the blending assembly includes a blender base and a container removably mountable on the blender base and the container includes an integral dispensing spout and dispensing valve that opens and closes the dispensing spout. The method may comprise the steps of mounting the container to the blender base; adding ingredients to the container either before or after the step of mounting the container to the blender base; blending the ingredients in the container; actuating the dispensing valve to open the dispensing spout, thereby dispensing the blended ingredients from the container; actuating the dispensing valve to close the dispensing spout; adding rinse water to the container; and actuating the dispensing valve to close the dispensing spout, thereby dispensing the rinse water from the container.

Other objects, advantages and salient features of the invention will become apparent from the following detailed description, which, taken in conjunction with the annexed drawings, discloses a preferred embodiment of the present invention

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an isometric view of a blending assembly according to an exemplary embodiment of the invention;

FIG. 2 is a perspective view in section of a blender base and valve of the blender assembly illustrated in FIG. 1, showing the valve in a closed position; and

FIG. 3 is a perspective view in section of the blender assembly similar to FIG. 2, showing the valve in an open position.

### DETAILED DESCRIPTION OF THE EXEMPLARY EMBODIMENT

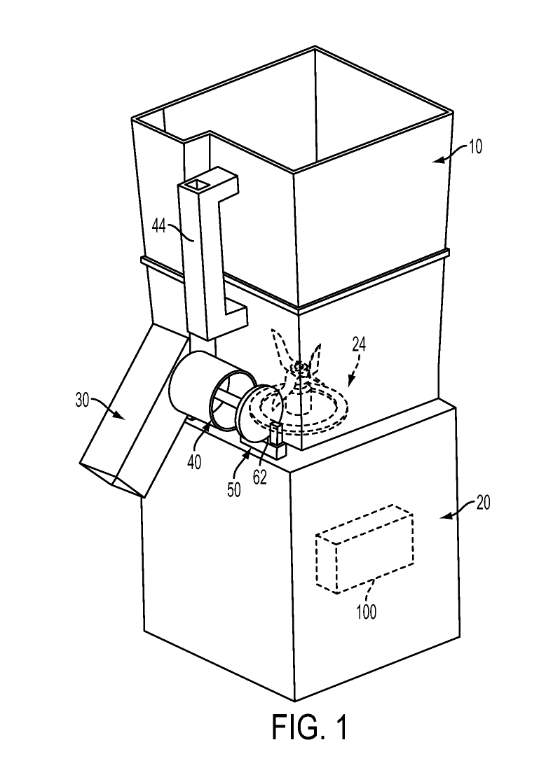

Referring to FIGS. 1-3, the present invention provides a blending assembly according to an exemplary embodiment that generally includes a blending container 10 removably disposable on a blender base 20. The container 10 may incorporate a conventional rotating impeller 24 at its base, a dispensing spout 30, a dispensing valve 40 and a handle 44. The container may optionally include a lid (not shown). The blender base 20 includes a drive motor that engages the rotating impeller 24 and an actuating mechanism 60 on the base that engages the dispensing valve 40 when the container 10 is placed onto the blending base 20. The dispensing valve 40 is of the normally-closed type. The actuating mechanism 60 engages dispensing valve 40 when container 10 is placed onto blender base 20. The container and base may be made of plastic, glass or metal.

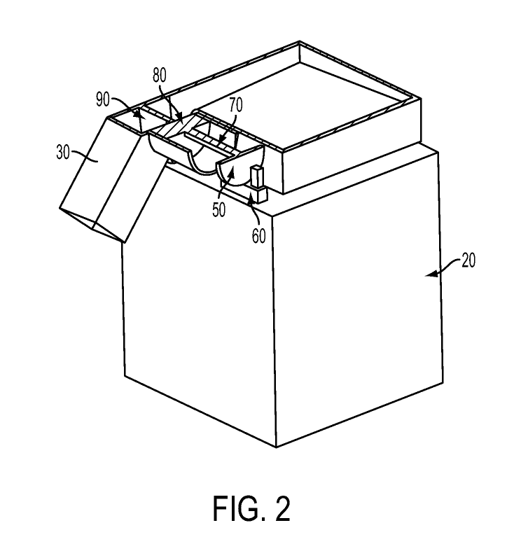

The dispensing spout 30 and dispensing valve 40 are preferably integrated with the blending container 10 and the dispensing valve 40 is operated automatically by the control mechanism 100 in the blender base 20. The dispensing valve 40 is normally closed, as seen in FIG. 2, to allow an operator to remove the container 10 from the blender base 20 and fill the container 10 with ingredients while the container 10 is sealed or closed by the valve 40. Thus no ingredients can leak from the container 10 during this step.

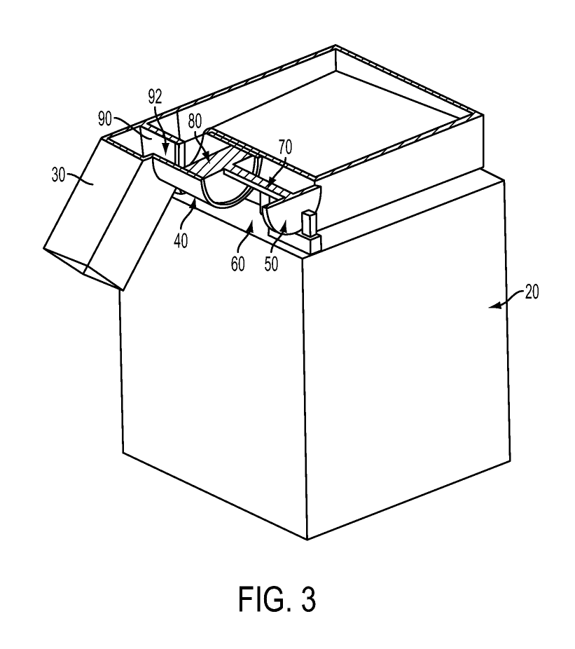

The dispensing valve 40 may operate, for example, by providing a flange 50 on the valve 40 that is receivable in a slot 62 of the moving actuating mechanism 60 on the blending base 20. Flange 50 may be linked to a piston 70 of the valve 40. Piston 70 may have a rubber head 80 that seals against a barrier wall 90. When the piston 70 is closed, the head 80 seals against the barrier wall 90, thereby sealing the mixture or ingredients in the container, as seen in FIG. 2. When actuating mechanism 60 is moved to the right (by a stepper motor, for example), the piston 70 and head 80 move away from wall 90, as seen in FIG. 3. This opens a passageway 92 for the mixture to pass by wall 90 and exit the container through the dispensing spout 30.

When the container 10 is returned to the blender base 20, the system automatically continues the drink preparation steps of blending the beverage (via the rotating impeller 24 of the base 20), dispensing the beverage via the dispensing spout 30 as described above, rinsing the container with water and then draining the water from the container via the dispensing spout 30. The blender base 20, which preferably includes the control mechanism 100, operates the dispensing valve 40 during this sequence such that the valve 40 is closed during blending and rinsing operations, and open during the dispensing and draining operations. Because the dispensing spout 30 and valve 40 are incorporated into the blending container 10, running the container 10 through a dishwasher insures that all food-contact surfaces are sanitized by the high-temperature wash.

The blending assembly of the present invention is designed to improve the function of prior art blenders. The blending container 10 is mounted on blender base 20 and the impeller is disposed inside the base 20 of container 10. The motor is inside the blender base and engages with the impeller inside container 10. The embodiment of dispense valve 40 in FIG. 1 is a piston type valve, as described above, that closes the dispensing spout 30 when the piston is moved inward, and opens the dispensing spout 30 when the piston is moved outward. Other types of normally closed valves could be used in place of the valve 40 shown in FIGS. 1-3.

To make a smoothie or other beverage with the invention, the operator first fills the blending container 10 with the desired beverage ingredients. This may be done either with the blending container 10 on the blending base 20 or removed from the blending base 20. Since the dispensing valve 40 is normally closed, no ingredients leak from the container 10 during this step regardless of whether the container 10 is on top of the blender base 20 or not. Once all the ingredients have been added, the container 10 is returned to the blender base 20 such that both the impeller and the dispensing valve 40 engage with the corresponding motor and actuating mechanism 60 in the blending base 20.

At this point the operator may initiate the blending sequence by pressing a button (not shown) connected to the control mechanism 100. The motor in the blender base 20 then energizes for a predetermined period of time to turn the impeller and blend the beverage. The control mechanism 100 then actuates the actuating mechanism 60 to open the dispense valve 40 allowing the beverage to exit the container through the dispensing spout 30 and into a cup. Once the beverage has dispensed, the control mechanism actuates the actuating mechanism 60 to close the dispensing valve 40. Rinse water may then be directed into the container 10 for rinsing. For example, rinse water may be sprayed into the top of the container such that all walls of the container are wetted by the spray. After a preset time, the control mechanism 100 actuates the actuating mechanism 60 opens the dispense valve 40 to expel the rinse water. Once the rinse water has dispensed, the dispense valve 40 is closed by the actuating mechanism 60 via the control mechanism 100 and the impeller motor is de-energized. The container 10 is now ready to prepare a subsequent beverage. The control mechanism 100 and the motor operate the impeller 24 to turn through all of the steps of blending, assisting in beverage dispensing, assisting in container 10 rinsing and helping expel the rinse water. The impeller 24 may be turned while the valve 40 to facilitate dispensing of the thick mixture out of the container 10.

The rinsing step described above is needed to clean the smoothie ingredients that did not dispense from the container to prevent product spoilage between beverages and to prevent potential cross-contamination between different smoothie types (e.g., strawberry and raspberry). To sanitize the container 10, the container 10 may be run through a dishwasher at predetermined intervals (e.g., every four hours), for example. Depending on the type of dispensing valve used, some disassembly of the valve may be done prior to each wash in a dishwasher.

While a particular embodiment has been chosen to illustrate the invention, it will be understood by those skilled in the art that various changes and modifications can be made therein without departing from the scope of the invention as defined in the appended claims.

What is claimed is:

1. A blending assembly, comprised of:
a blender base having an actuating member and a control mechanism; and
a container removably mountable on said blender base, said container having an integral dispensing spout and dispensing valve, said dispensing valve opens and closes said dispensing spout, said container being adapted to receive ingredients,
whereby said control mechanism operates an impeller of said container to blend the ingredients and operates said actuating member to engage said dispensing valve to move said dispensing valve between open and closed positions with respect to said container, thereby opening and closing said dispensing spout for dispensing the blended ingredients.

2. A blending assembly according to claim 1, wherein
when said container is removed from said blender base, said dispensing valve is in a closed position, thereby closing said dispensing spout.

3. A blending assembly according to claim 1, wherein
said dispensing valve includes a piston for moving said dispensing valve between open and closed positions.

4. A blending assembly according to claim 1, wherein
said piston includes a flange at one end and a sealing member at an opposite end.

5. A blending assembly according to claim 4, wherein
said flange engages said actuating member and said sealing member engages said dispensing spout.

6. A blending assembly according to claim 4, wherein
said flange engages a slot of said actuating member.

7. A blending assembly according to claim 1, wherein
said container includes a handle.

8. A blending assembly, comprised of:
a blender base;
a container removably mountable on said blender base, said container having an integral dispensing spout and dispensing valve, said dispensing valve opens and closes said dispensing spout, said container being adapted to receive ingredients; and
a means for automatically actuating said dispensing valve between open and closed positions and dispensing the ingredients from said container.

9. A blending assembly according to claim 8, wherein
said means for automatically actuating said dispensing valve includes a control mechanism that operates an actuating member to engage said dispensing valve and move said dispensing valve between open and closed positions with respect to said container, thereby opening and closing said dispensing spout for dispensing the blended ingredients.

10. A blending assembly according to claim 8, wherein
said control mechanism operates an impeller of said container to blend the ingredients.

11. A blending assembly according to claim 8, wherein
when said container is removed from said blender base said dispensing valve is in a closed position, thereby closing said dispensing spout.

12. A blending assembly according to claim 8, wherein
said dispensing valve includes a piston for moving said dispensing valve between open and closed positions.

13. A blending assembly according to claim 12, wherein
said piston includes a flange at one end and a sealing member at an opposite end.

14. A blending assembly according to claim 8, wherein
said container includes a handle.

15. A method of operating a blending assembly, the blending assembly including a
blender base and a container removably mountable on the blender base wherein
the container includes an integral dispensing spout and dispensing valve that
opens and closes the dispensing spout, comprising the steps of:
mounting the container to the blender base;
adding ingredients to the container either before or after the step of mounting the container to the blender base;
blending the ingredients in the container;
actuating the dispensing valve to open the dispensing spout, thereby dispensing the blended ingredients from the container;
actuating the dispensing valve to close the dispensing spout;
adding rinse water to the container; and
actuating the dispensing valve to close the dispensing spout, thereby dispensing the rinse water from the container.

16. A method according to claim 15, wherein
the dispensing valve is actuated by a control mechanism in the blender base.

17. A method according to claim 16, wherein
the control mechanism operates an actuating member on the blender base that is coupled to the dispensing valve.

18. A method according to claim 16, wherein
the control mechanism operates an impeller of the container to blend the ingredients in the container.

19. A method according to claim 15, further comprising the step of
removing the container from the blender base such that the dispensing valve automatically closes, thereby closing the dispensing spout.
